(19) United States
(12) Patent Application Publication
(10) Pub. No.: US 2007/0275360 A1
(43) Pub. Date: Nov. 29, 2007

(54) Collection of Cytological and Histological Models of Human Embryonic and Fetal Development for Visually Impaired Persons

(76) Inventors: Maria Das Gracas Ribeiro, Belo Horizonte-MG (BR); Valeria De Cassia Resende, Belo Horizonte-MG (BR); Junea Mara Concalves Moraes, Belo Horizonte-MG (BR); Christiane De Fatima Tavares, Belo Horizonte-MG (BR); Daniele Sirineu Pereira, Belo Horizonte-MG (BR); Tatiana Pessoa Da Silva Pinto, Belo Horizonte-MG (BR)

Correspondence Address: NIXON & VANDERHYE, PC, 901 NORTH GLEBE ROAD, 11TH FLOOR, ARLINGTON, VA, 22203, US

(21) Appl. No.: 10/576,874

(22) PCT Filed: Oct. 21, 2004
(86) PCT No.: PCT/BR04/00206

§ 371 Date: May 1, 2007

(30) Foreign Application Priority Data
Oct. 22, 2003 (BR) PI 0305646-5

(51) Int. Cl. G09B 23/26

(52) U.S. Cl. 434/278

(57) ABSTRACT

The collection of 41 three-dimensional products, 11 raised products, and a process of didactic interpretation in printed form and in Braille aim at the educational inclusion and improvement of the teaching-learning process of Morphological Sciences, in general, and especially for the visually handicapped, facilitating the association of theoretical concepts to the perception of the form, dimension, topography and proportions of the organic structures being studied.

The present invention is a collection of 52 biological products, 41 of which are three-dimensional, 11 in relief, including an interpretative process in printed form and in Braille for the purpose of making the teaching and learning of the biological sciences more efficient and inclusive, mainly with respect to morphology, especially intended for, but not restricted to, the visually handicapped.

It is well-known that visual handicaps are a reality for thousands of citizens throughout the world. On Sep. 14, 2001, the guiding principles proposed by the Inter-American Convention came into force, which decreed the Elimination of All Forms of Discrimination Against Handicapped People (Legislative Decree No. 198). And yet, although the Brazilian Constitution guarantees people with special learning needs the right to enjoy all the rights of the common citizen, the visually handicapped have found little opportunity even when it has been a question of their basic education.

With respect to basic and intermediate instruction, these citizens can count on very few specialized centers that will guarantee them a formal education. There are countless institutions that, even when they struggle to implement quality instruction, have neither the resources nor the specialized teaching tools to meet the general and specific requirements of these students, who most of the time have not been able to engage in inclusive activities.

In higher education, this situation is even more serious, for in spite of the “democratic” selection process, which even offers opportunities to those with special educational needs to enter colleges and universities, access to one of these institutions is a nearly impossible dream for many of these students, whose greatest struggle is still the one for a basic education of quality. Even more surprising is the fact that the visually handicapped enter a university and do not find what they require for their professional training, like bibliographies in Braille, adequate material for their practical classes, proper workshops and/or laboratories and trained teachers.

The absence of specialized materials makes the learning process even more limiting with regards to the study of human morphology. Morphology involves the study of the individual constitution, including contents from anatomy, cytology, histology, and embryology. The teaching of this content is essentially practical, requiring teaching resources like photomicrographs, histological slides, and anatomical pieces of great visual appeal, which prevent the visually handicapped from using them. Their learning has been based on listening to cassette tapes recorded by relatives or helpers of good will, since a collection of biological products covering all the areas of morphology—cells, tissues, organs (isolated and/or joined together in systems), embryos and fetuses, specifically intended for the special needs of these individuals still does not exist in the market, as attested by bibliographical research and investigations of patent banks.

The absense of these didactic resources necessary for learning has the effect of restricting the right of the visually handicapped to quality instruction, the access to information, and the scientific and technological development in this area. These limitations, in effect, lead to difficulties in school and to educational exclusion of these individuals, and may also culminate in obstacles to their professional qualification and insertion in the job market. At present, only in some schools of higher education are three-dimensional pieces, made of resin, used for the study of human embryology and macroscopic anatomy. There are, however, restrictions regarding their use for the visually handicapped, since they are not specific to needs such as: the possibility of handling and manually exploring the cells, tissues, and organs; variation in the size of the pieces for better understanding of the structures under study; pieces that can be disassembled and reassembled, according to the functional study of the structure.

The present invention has as one of its objectives the training of specialized teachers and the improvement of the teaching and learning process for the visually handicapped in basic, intermediate, and higher education, making classes and/or practical activities in cytology, histology, anatomy, and embryology more dynamic and interactive, as well as improving the teacher-student relationship and the relation of the student with the objects of study, both in the classroom and in science centers, museums, and other places.

The three-dimensional products and products in relief, as well as the interpretative process, facilitate the association of theoretical concepts with the perception of form, dimension, topography, and proportion of the structures being studied. In this way, the visually handicapped are capable of recognizing the cellular, histological, anatomical, and embryonic structures, correlating their morphological and functional aspects. They are also capable of understanding, on the basis of previous study, the relation between the location of each structure and the various functions performed by the organism, including the different levels of organization of the human body. The products are initially presented in approximately natural size and later enlarged so that the student may study them in detail. Several products represent the internal structures of the organs, in longitudinal or transverse sections. One must consider the need for the existence of teaching tools that facilitate understanding, such as a guiding process for the use of the products, since topographical exploration (forms, textures, raised or sunken parts, dimensions), that is, an isolated biological product with no guidance for its specific use, cannot satisfy the learning needs of the visually handicapped. The study of each product is guided by means of an explanatory product, printed or in Braille, which facilitates learning. Another important point that justifies making a process whose purpose is to guide the student's hands over the piece is that the student may thereby become independent of third parties for understanding the theoretical and practical contents.

The invention is based on the need for teaching resources for the visually handicapped, with respect to the study of morphology, keeping in mind their special needs of learning through touch. Three dimensional biological products and biological products in relief reproduce the structure of cells, cellular parts, tissues, phases of embryonic and fetal development, and organs, portraying the human body as closely as possible to what it actually looks like. The proceedures for making and reproducing these biological products were developed in stages, and for this purpose different materials, methods, and techniques were used. The interpretative process is composed of two distinct parts: the first is intended to furnish theoretical-methodological support for the study of each product, and the second intended as a guide to the use of the products through their detailed descriptions.

The invention includes both the handling of the collection of biological products and the interpretative process. All the products of the collection were minutely tested with visually handicapped people for the purpose of finding a common objective for the creation of the products and the needs and expectations of their target-public. The response given by the visually handicapped in their use of these products showed their fundamental importance, for by means of the response various adaptations were made, until each product, as well as the interpretative process, corresponded to the specific needs of these individuals.

A fundamental component for the success of the present invention was the choice of materials appropriate to the manufacture of the products described above. In the course of the experiments, various materials were tested, and several factors, such as practicality, pliability, and durability were considered, and the most adequate for use and manufacture were chosen.

The products can be modelled in any moldable material, preferably in clay. The choice of this material was based on the fact that it is the most pliable material, allowing not only remodelling, but also grooving in different depths, as well as allowing a great variety of textures and contours. The use of clay is also advantageous, as it allowed several adaptations be made after the experimental use with the visually handicapped, even when the products were nearly ready. At the end of the modelling process, the products are fired in a specific oven, like those available on the market. With a temperature of approximately 1200° C., the clay undergoes modifications in its molecular structure, turning into a ceramic. The aim of the firing is for the products to acquire resistance for future reproduction. With the conclusion of the stages of modelling, firing, and form-production, the next step is the reproduction of the products in a definitive material.

During the experiments, the use of plaster was seen to be advantageous, as it is an economically viable, resistant, and very durable material. Within these characteristics, resistance becomes indispensable, since the visually handicapped sometimes need to use a firmer grip to better explore the pieces, which will be constantly handled, requiring superior resistance and durability. The last part of the process of manufacturing the three-dimensional products consists of their being painted different colors to differentiate each structure or stuctural complex. The painting of the products aims at making them more attractive to the students who can see, with the aim of including everyone in the learning process. The choice of colors was made according to didactic criteria: for the first product of the collection, the cell and its parts, the colors used were white for the cell membrane, transparent for the cytoplasm, royal blue for the nucleus, red for the mitochondria, yellow for the rough endoplasmic reticulum, light green for the smooth endoplasmic reticulum, dark green for the Golgi materials, lilac for the lysosomes, pink for the centrioles. In the products that represent these parts separately, the respective colors are maintained, which makes for easier memorization. For the products representing the tissues, the following colors were used: yellow for epithelial, light pink for loose connective tissue, dark pink for the thick connective tissue, red for muscle tissue, green for bone tissue, blue for nerve-neuron tissue. In the products representing the different organs, the colors corresponding to the tissues composing are used, both in the three-dimensional products and products in relief.

For the biological products in relief, the choice of material also followed criteria such as durability and resistance. With relation to the peculiarity of the portion in relief, the raised portion, the criterion aimed at choosing a material that made the raised portion high enough to allow the perception of the structure under study by the visually handicapped. After several tests, wood was decided upon as the support and the relief was made in plaster (the pastille technique).

The production of a didactic interpretative process, an integral part of the present invention, is one of the outstanding parts of this collection. The interpretative process features a practical-technical guide, whose aim is to guide the learning of the contents of the different areas of morphology. The interpretative process consists of two parts: the first describes the theoretical content, and the second describes each product of the collection. It is important to note that in the first part, besides the classical approach of cytology, histology, anatomy, and embryology, there is also a description of basic aspects of the physiology of the structures studied, which enriches the interdisciplinary approach. In the second part, the products are described in detail, each structure belonging to the collection being described in turn. The aim of the description of the products is to guide the hands of the visually handicapped over the product, making it easier for them to associate the basic content with the three-dimensional representation of the structures under study, making possible, according to the text, “ . . . the formation of images that will make learning more associative and enduring.”

The invention here described is given additional explanation in the attached illustrations, where the products that compose the collection are shown.

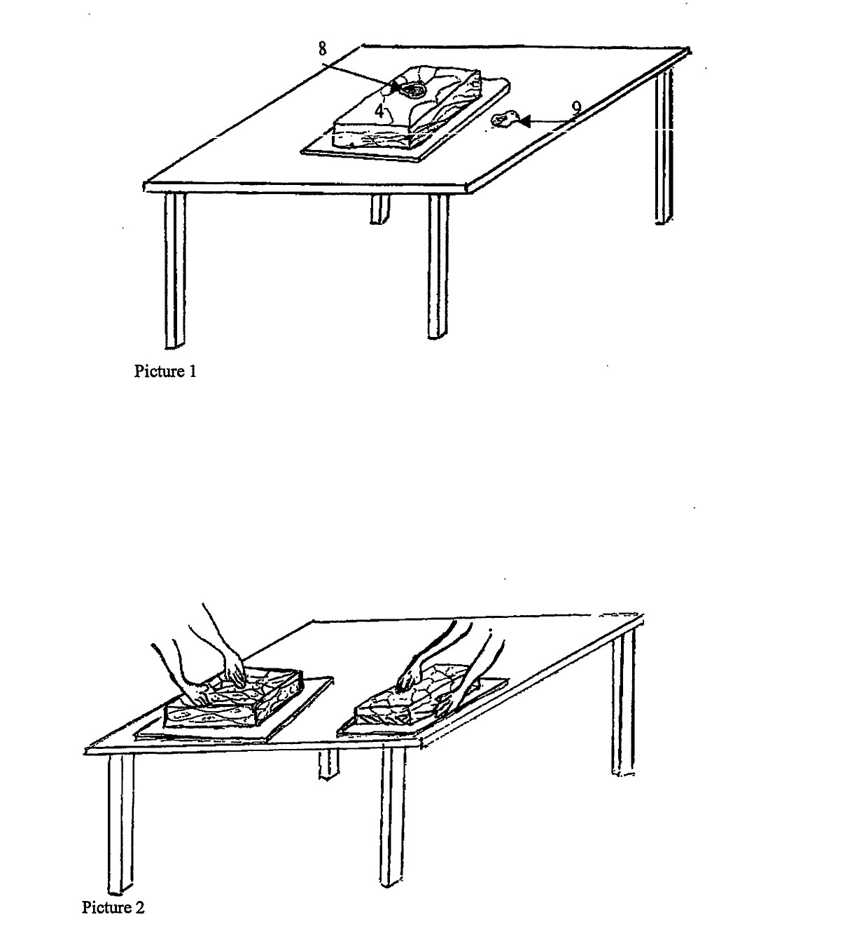

FIG. 1 shows the product (1) at the end of the modelling process, awaiting complete drying so that firing may take place. The dark part of the product (2) represents the absence of a cell (3), which has been purposely removed to show the students the Three-dimensional form of the cell, which is later fitted into the whole to form the represented tissue.

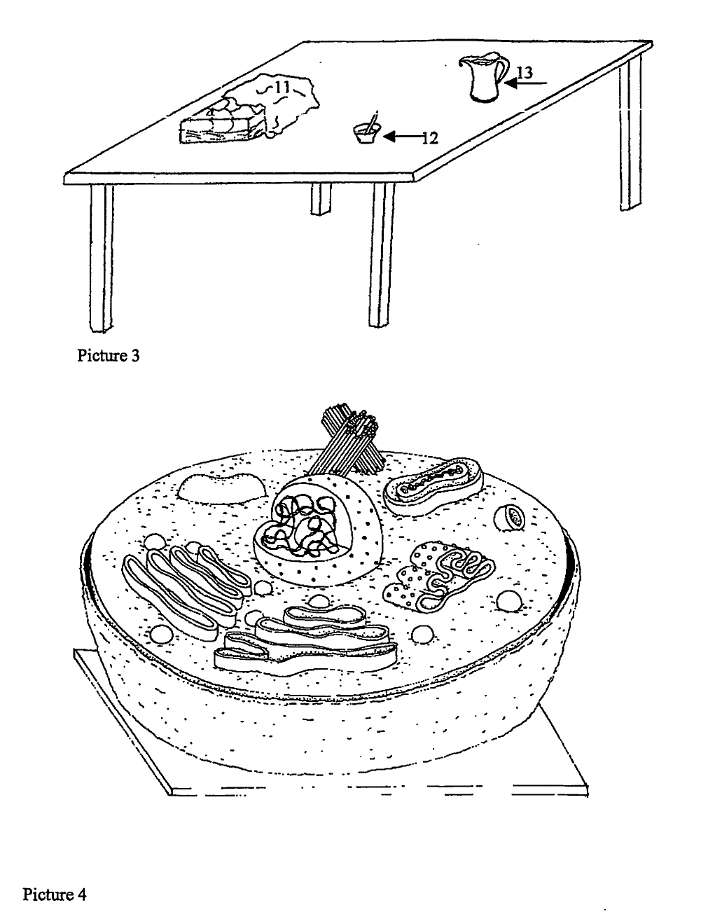

FIGS. 11 to 52 refer to the three-dimensional products.

FIG. 11 shows the product representing a cell in the form of a sphere, with a cross section that permits the (visual) perception of the arrangement of its parts, which in the present product are not represented in sizes proportional to each other, but respect the need of the visually handicapped to be able to recognize them by touch. The product is supported on a wooden base.

FIG. 12 shows the product representing a section of the rough endoplasmic reticulum supported on a wooden base; the spheres represent ribosomes attached to its outer membrane.

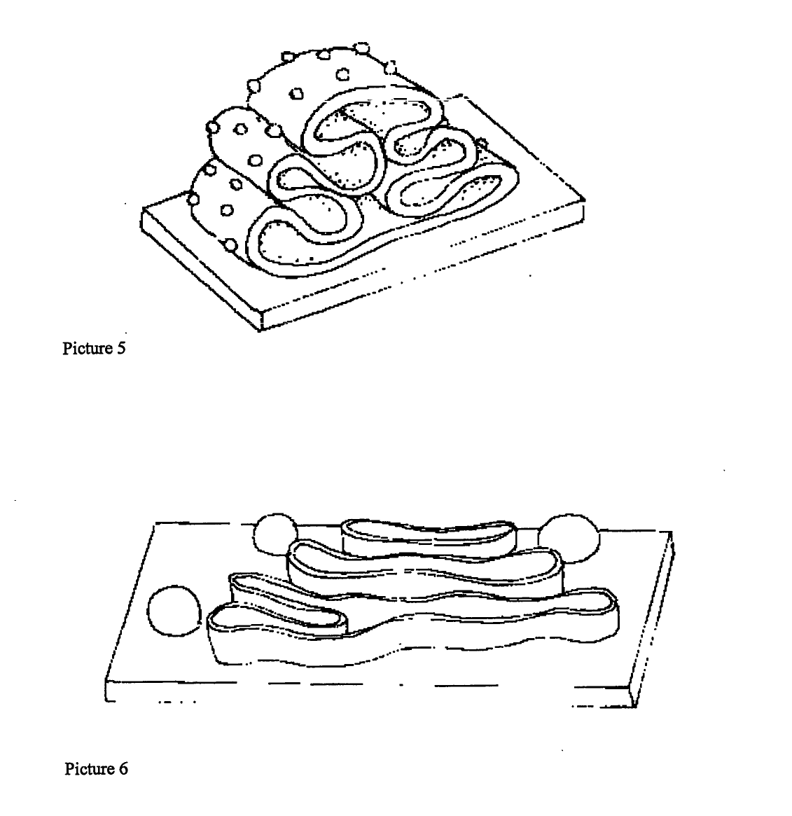

FIG. 13 shows the product representing a section of the smooth endoplasmic reticulum, supported on a wooden base.

FIG. 14 shows the product representing a Golgi body.

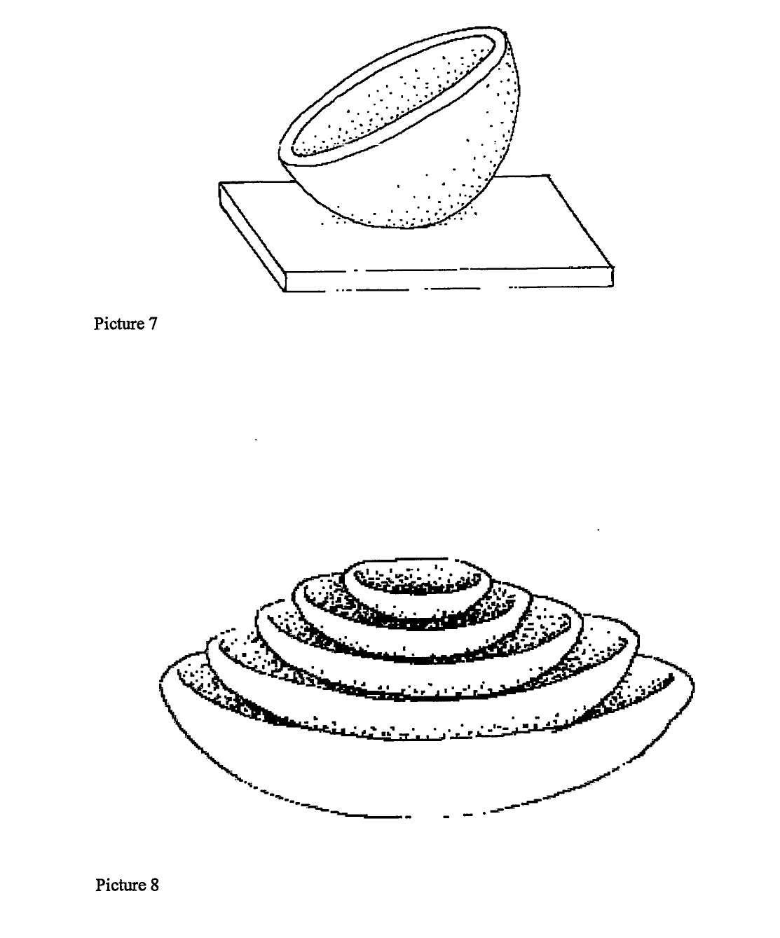

FIG. 15 shows the product representing a cross section of a Golgi body.

FIG. 16 shows the product representing a mitochondrion in cross section, supported on a wooden base, exposing the ruffled internal membrane.

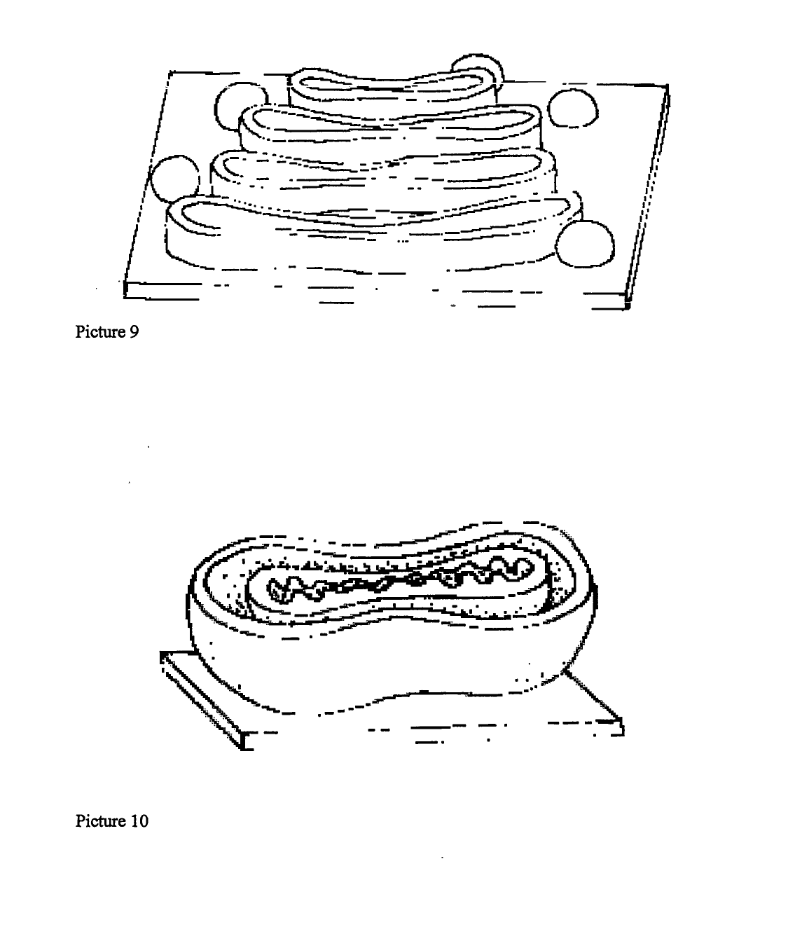

FIG. 17 shows the product representing a whole mitochondrion (closed).

FIG. 18 shows the product representing a pair of centrioles composed of nine triads of iron ⅝ in diameter, supported on a wooden base.

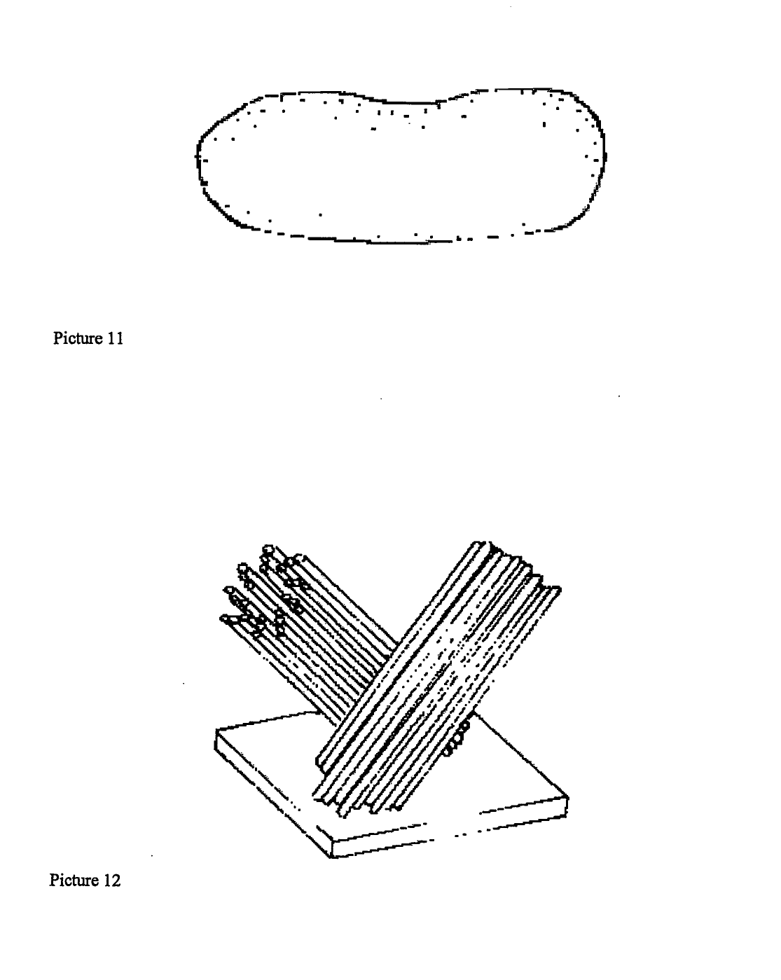

FIG. 19 shows the product representing a cell nucleus, supported on a wooden base, from which was removed part of the nuclear membrane, exposing nucleolus and chromatin.

FIG. 20 shows as a whole the product representing a section of simple squamous epithelial tissue, revealing the arrangement of the cells and their nuclei. On the surface of the product it is possible to remove one cell to understand its form. The epithelial cells rest upon connecting tissue. The product is supported on a wooden base.

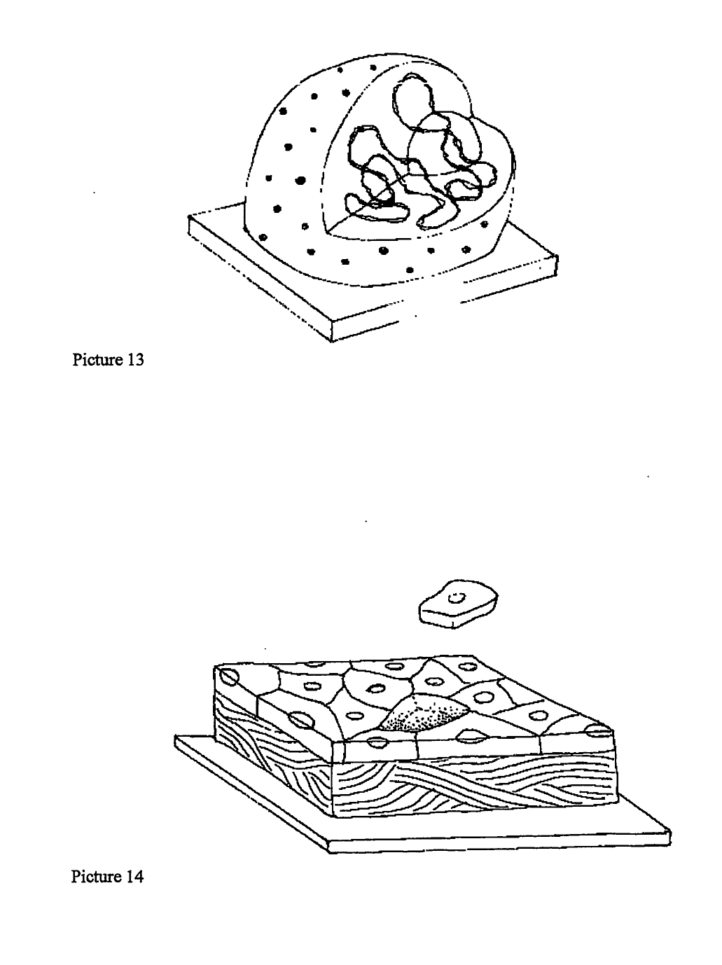

FIG. 21 shows as a whole the product representing a section of simple cuboidal epithelial tissue, revealing the arrangement of the cells and their nuclei. On the surface of the product, it is possible to remove one cell to understand its form. The epithelial cells rest upon connecting tissue. The product is supported on a wooden base.

FIG. 22 shows as a whole the product representing a section of simple ciliatpseudostratified epithelial tissue, revealing the arrangement of the cells and their nuclei. At the side of the product, it is possible to remove one cell of each type that exists in its structure to understand the respective forms. The epithelial cells rest upon connective tissue. The product is supported on a wooden base.

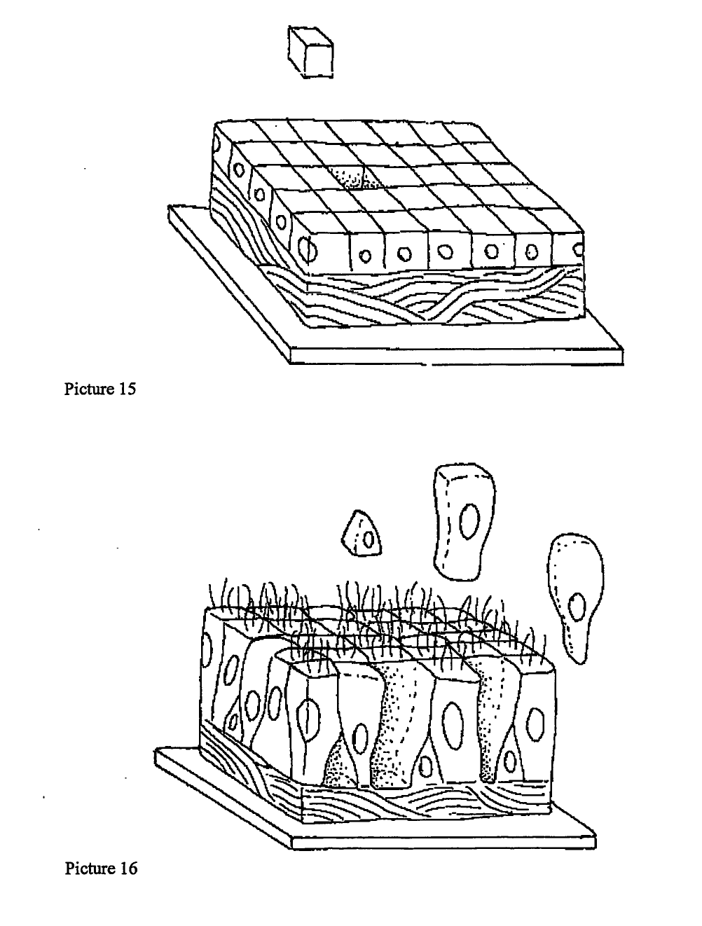

FIG. 23 shows as a whole the product representing a section of non-keratinized stratified squamous epithelial tissue, revealing the arrangement of the cells. The cells of the base layer rest on connective tissue. The product is supported on a wooden base.

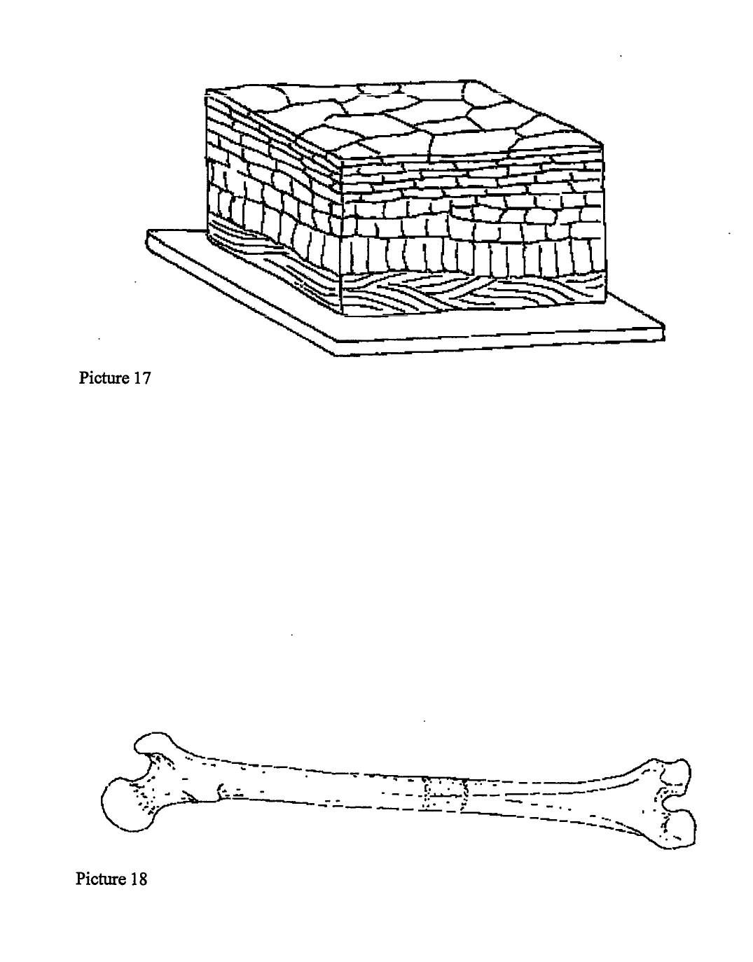

FIG. 24 shows the product representing a long bone, a femur, which with a raised ring in its middle area (1), indicating the next section (product) to be studied.

FIG. 25 shows a product representing a median section of the femur, revealing the spongy and compact tissues. The part in relief (groove) represents the next product to be studied. The product is supported on a wooden base.

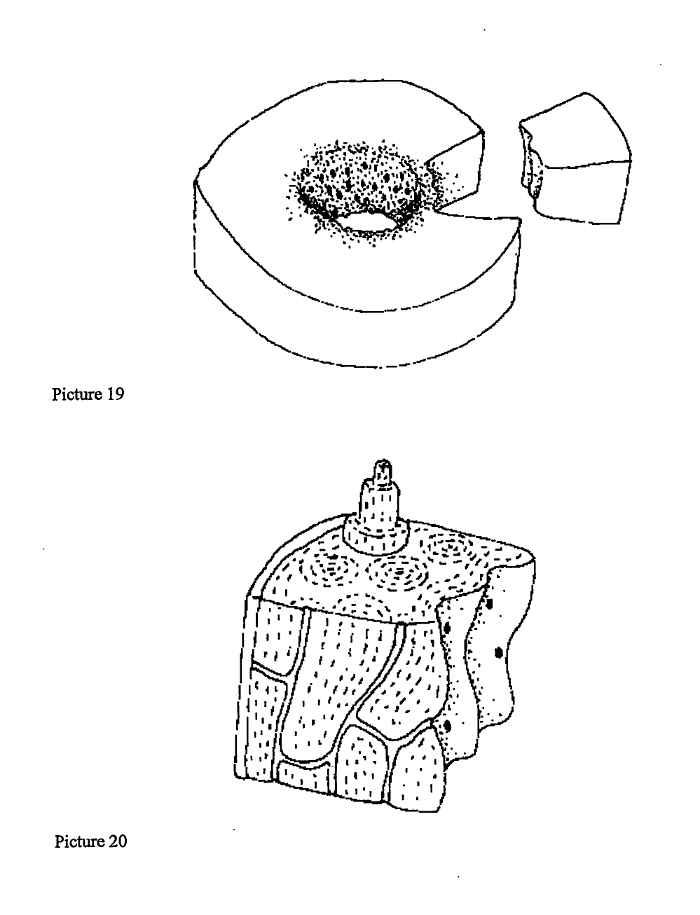

FIG. 26 shows en bloc the product representing a section of compact bone tissue, revealing the Havers and Volkmann canals. On the surface of the product it is possible to perceive Hayers systems, with one of them in relief to understand its make-up. The product is supported on a wooden base.

FIG. 27 shows the product representing a flat bone, a shoulder-blade.

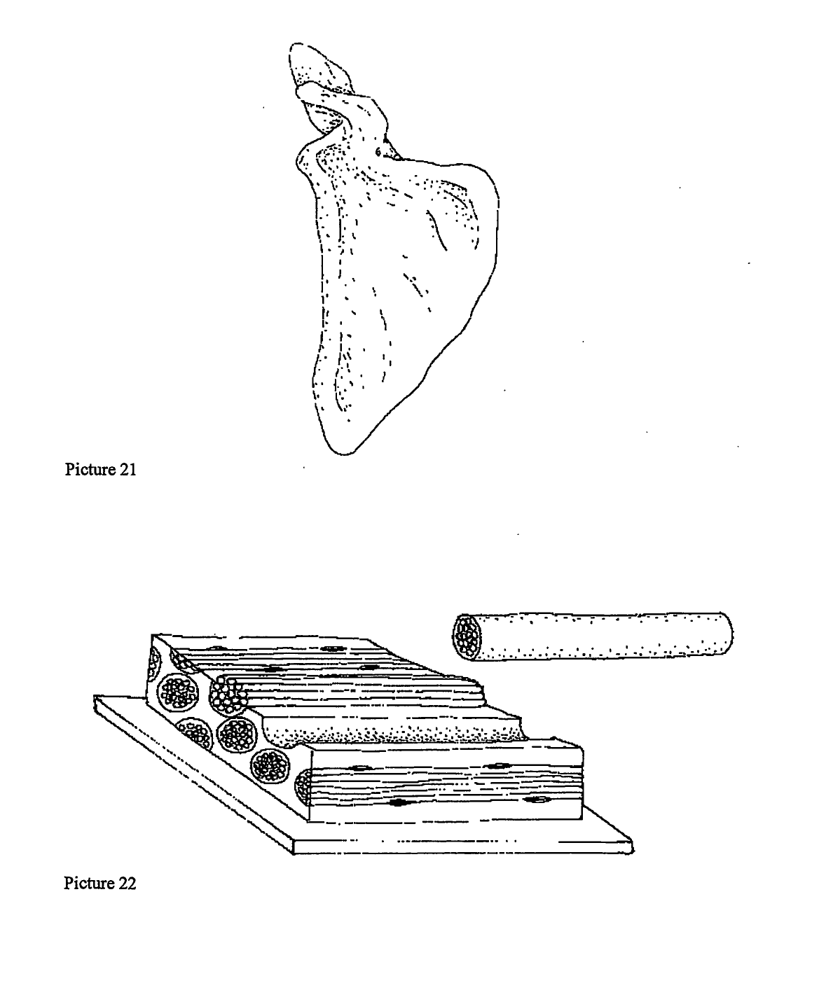

FIG. 28 shows en bloc the product representing a section of thin striated muscle tissue, revealing the arrangement of the cells and their nuclei. On the surface of the product, it is possible to remove one cell to understand its form. Still on the surface is found a cell whose membrane has been pulled back to reveal the internal structure (miofibriles). The product is supported on a wooden base.

FIG. 29 shows as en bloc the product representing a section of striated cardiac muscle tissue, revealing the arrangement of the cells and their nuclei. On the surface of the product, it is possible to remove one cell to understand its form; on the surface is also found a cell without a membrane to reveal the internal structure (miofibriles). The product is supported on a wooden base.

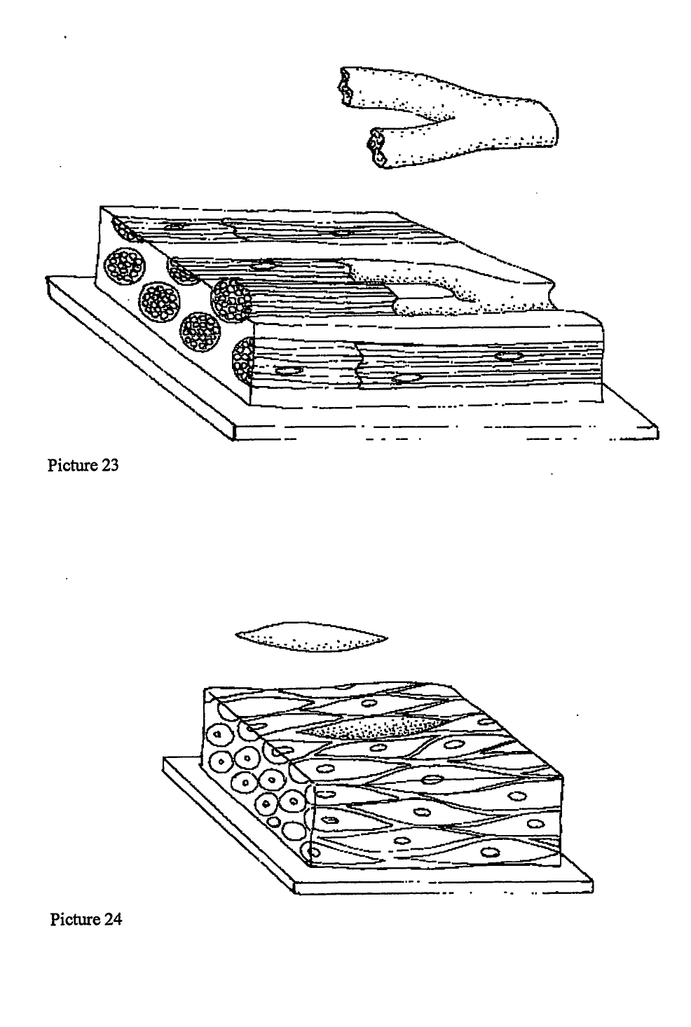

FIG. 30 shows en bloc the product representing a section of smooth muscle tissue, revealing the arrangement of the cells and their nuclei. On the surface of the product, it is possible to remove one closed cell to understand its form. The product is supported on a wooden base.

FIG. 31 shows the product representing a neuron, with some cuts showing its internal structures. The cut parts can be replaced to complete the cellular structure. The product is supported on a wooden base.

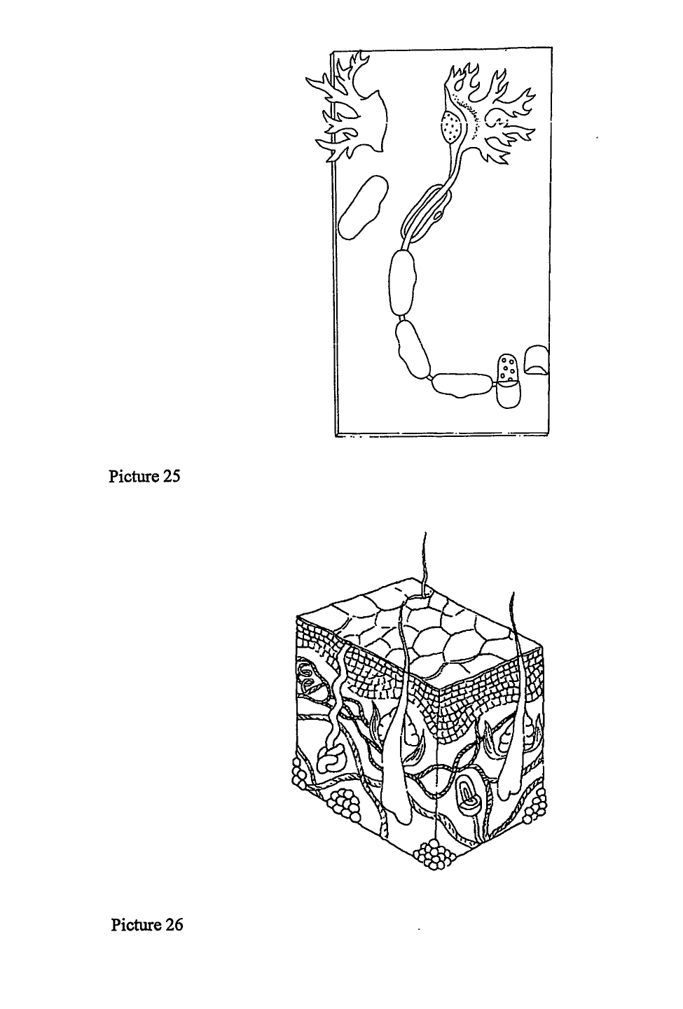

FIG. 32 shows en bloc the product representing a section of skin, revealing the structures composing it. The product is supported on a wooden base

FIG. 33 snows the product representing a heart and base veins and arteries, near to natural size.

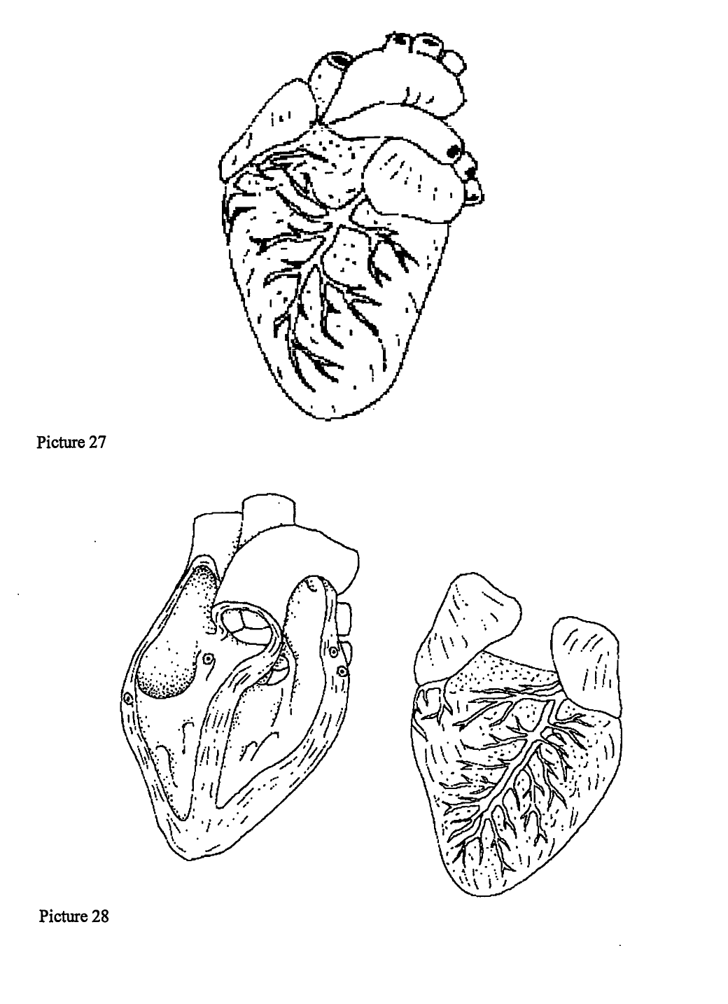

FIG. 34 shows the product representing a heart and base veins and arteries, larger than natural size, with cuts showing the internal structures

FIG. 35 shows the product representing a left lung, near to natural size.

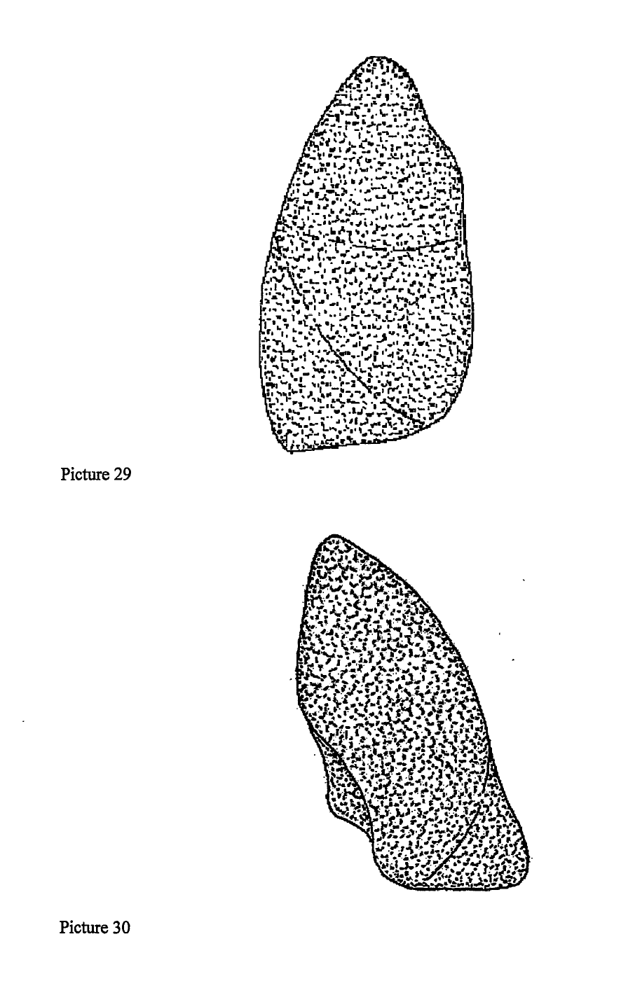

FIG. 36 shows the product representing a right lung, near to natural size.

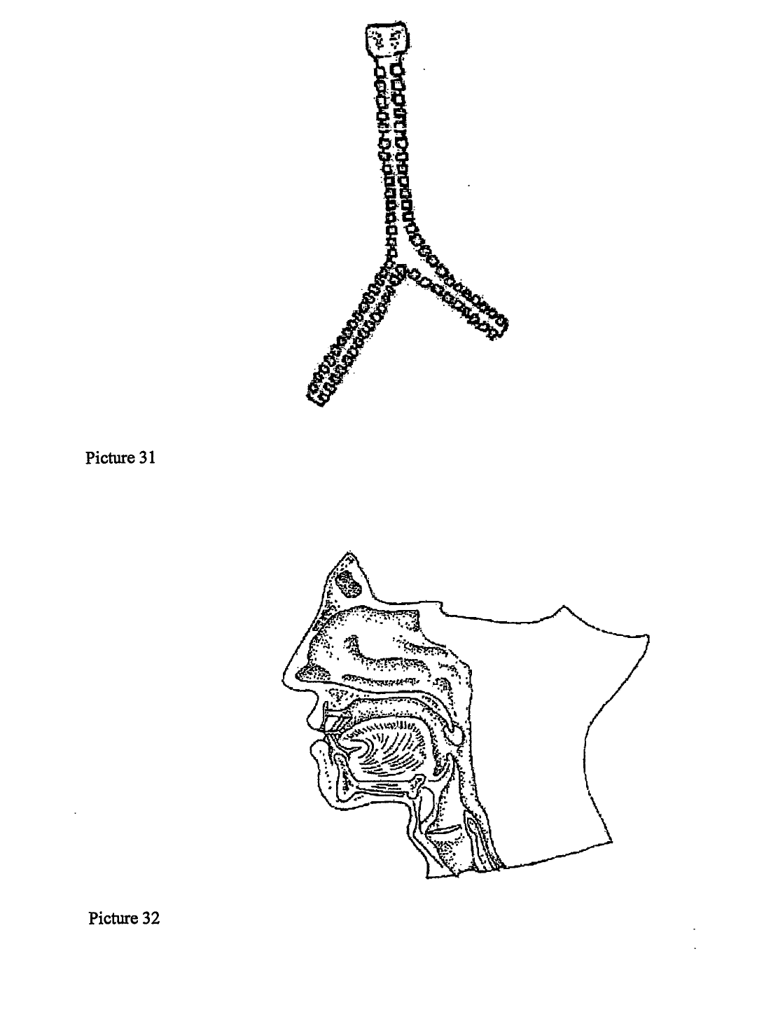

FIG. 37 shows the product representing trachea and bronchial tubes, near to natural size.

FIG. 38 shows the product representing a left paramedian section of the head, near to natural size, revealing the wall of the left nasal cavity. The product is supported on a wooden base.

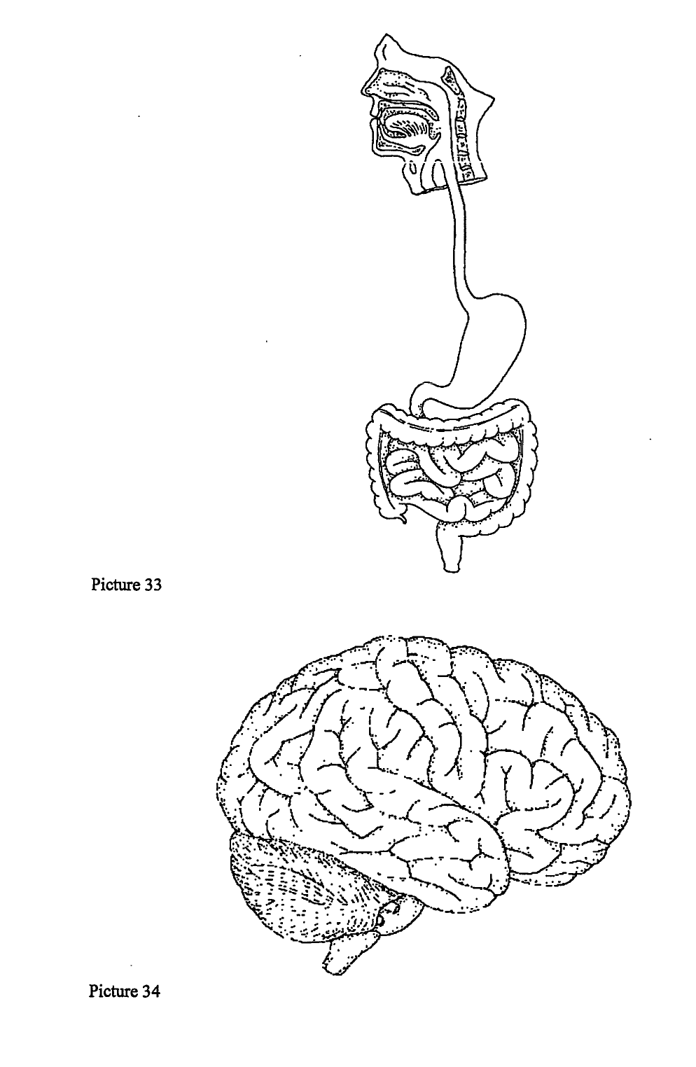

FIG. 39 shows the product representing a digestive system, near to natural size. The attached organs are not represented. The product is supported on a wooden base.

FIG. 40 shows the product representing a brain, near to natural size.

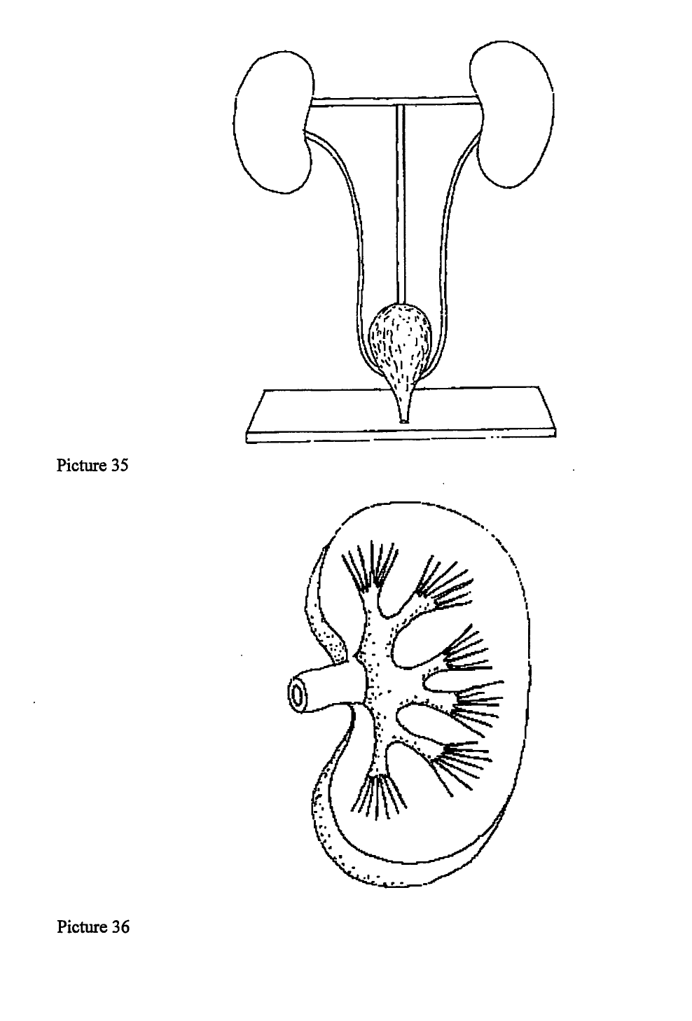

FIG. 41 shows the product representing a urinary system, near to natural size. The product is supported on a wooden base.

FIG. 42 shows the product representing a median section of the kidney, larger than natural size. The product is supported on a wooden base.

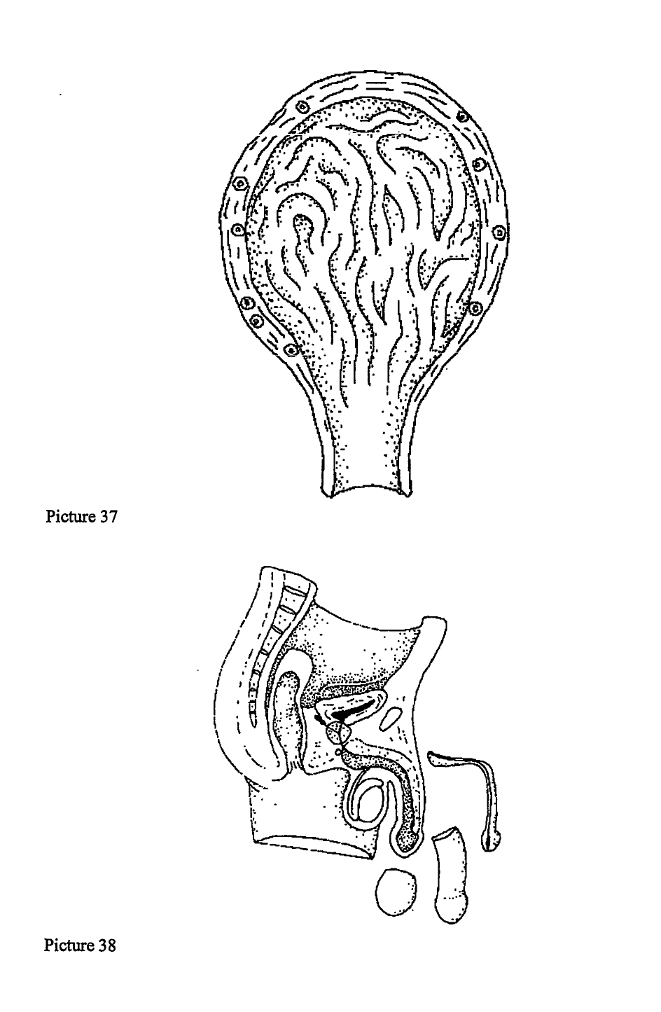

FIG. 43 shows the product representing a median section of the bladder, greater than natural size

FIG. 44 shows the product representing the male reproductive system, in median sagittal section, left side, near to natural size. The product is supported on a wooden base.

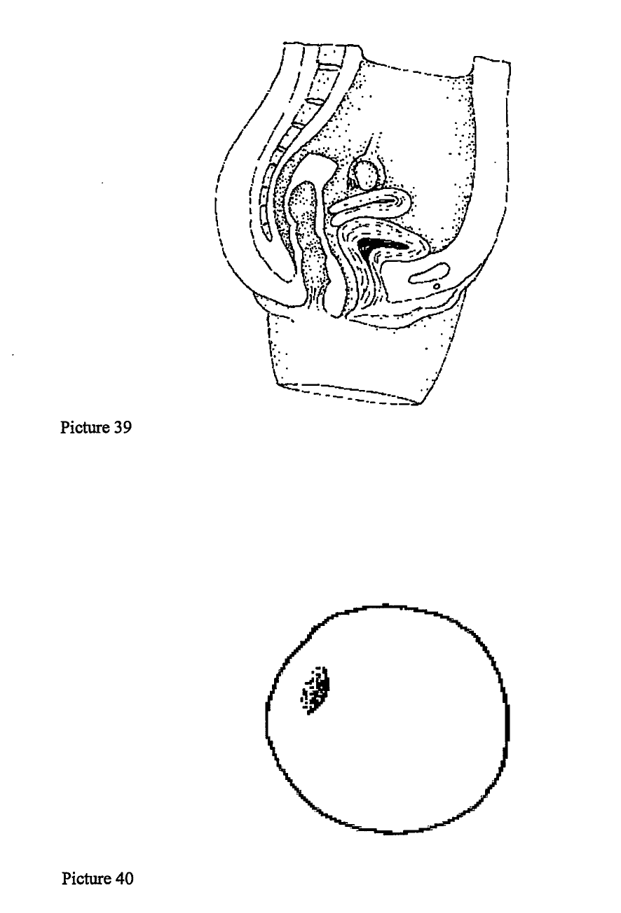

FIG. 45 shows the product representing the female reproductive system in median sagittal section, left side, near to natural size. The product is supported on a wooden base.

FIG. 46 shows the product representing an ovum, larger than natural size. The product is supported on a wooden base.

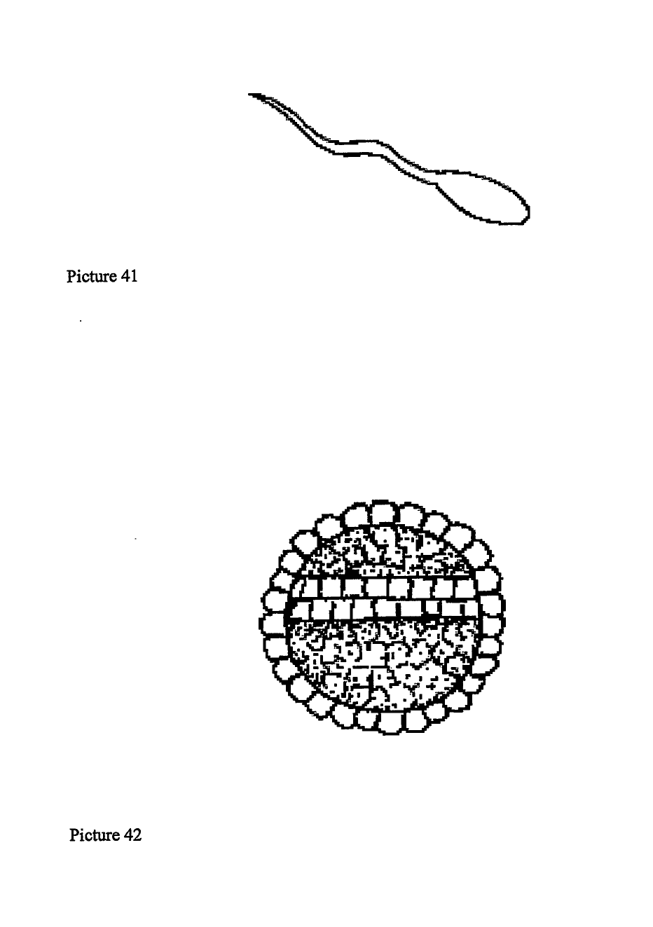

FIG. 47 shows the product representing a spermatazoon, larger than natural size.

FIG. 48 shows the product representing a morula, larger than natural size.

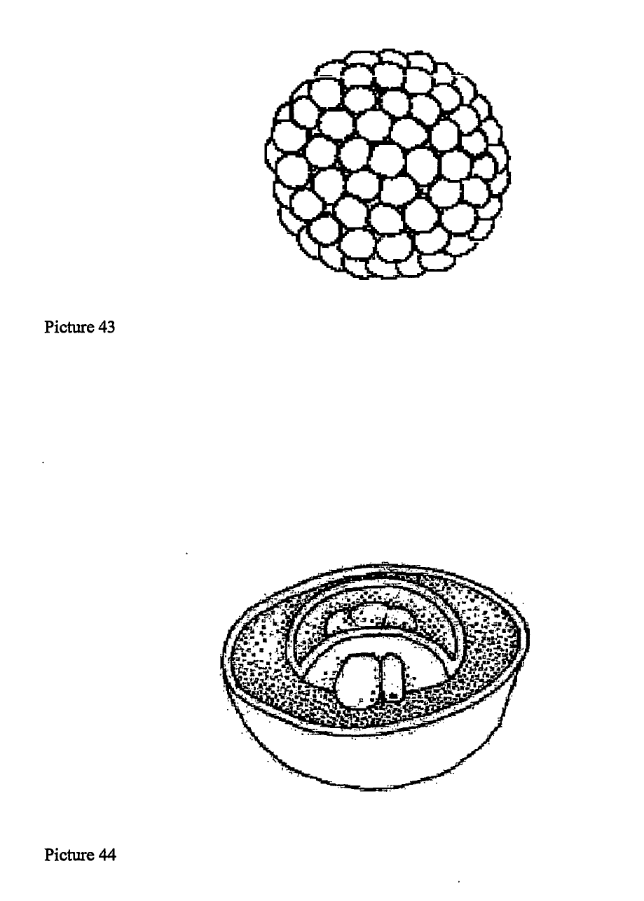

FIG. 49 shows the product representing a blastocyst, larger than natural size.

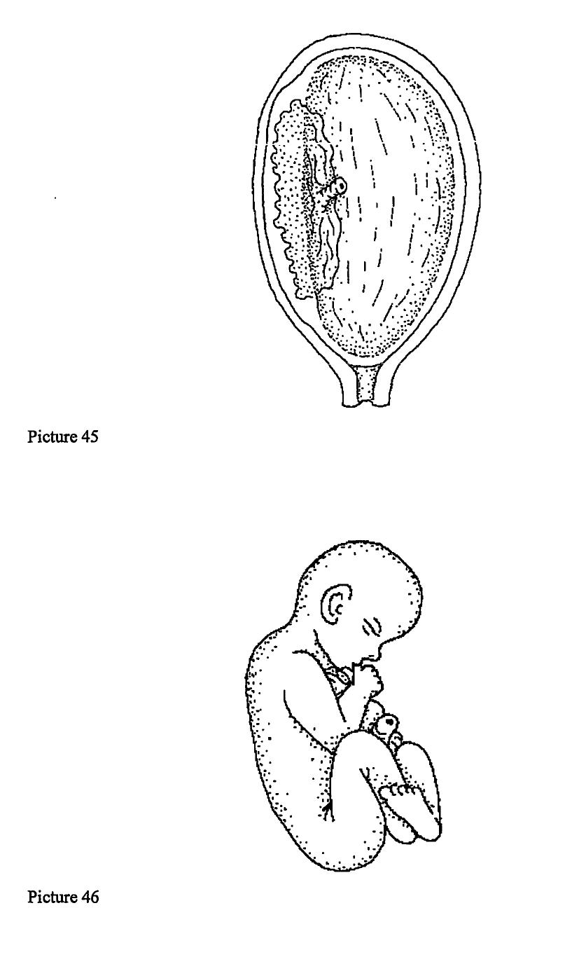

FIG. 50 shows the product representing a transversal section of the extra-embryonic and embryonic mesoderm, revealing a cylindrical embryo of approximately four weeks, larger than natural size.

FIG. 51 shows the product representing a median section of the uterus of a 38 week pregnancy

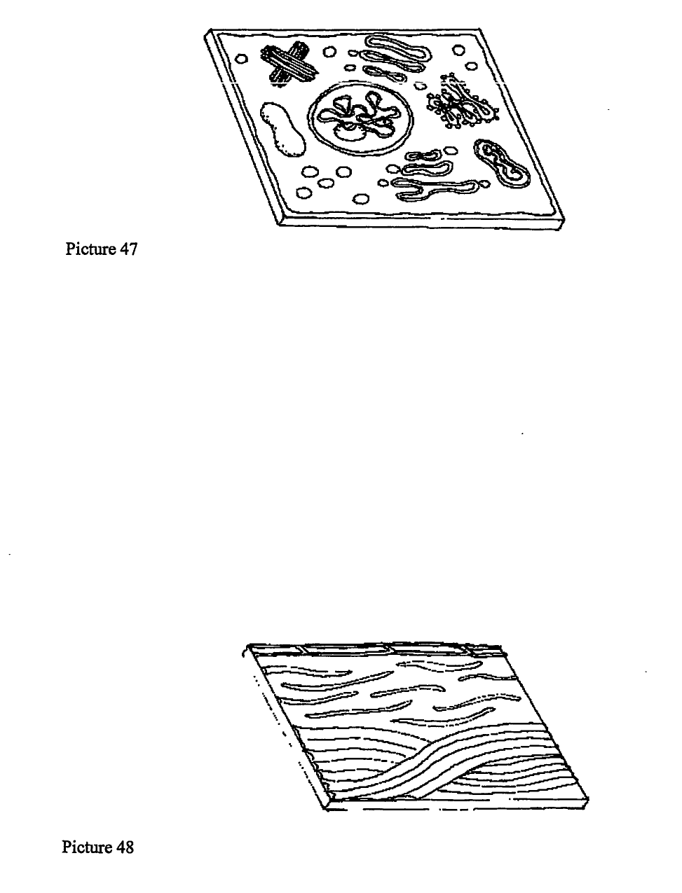

FIG. 52 shows the product representing a fetus of 38 weeks, near to natural size.

FIGS. 53 to 63 refer to the products in relief.

FIG. 53 shows, in relief, the product representing a cell, with its main parts, in greatly enlarged size.

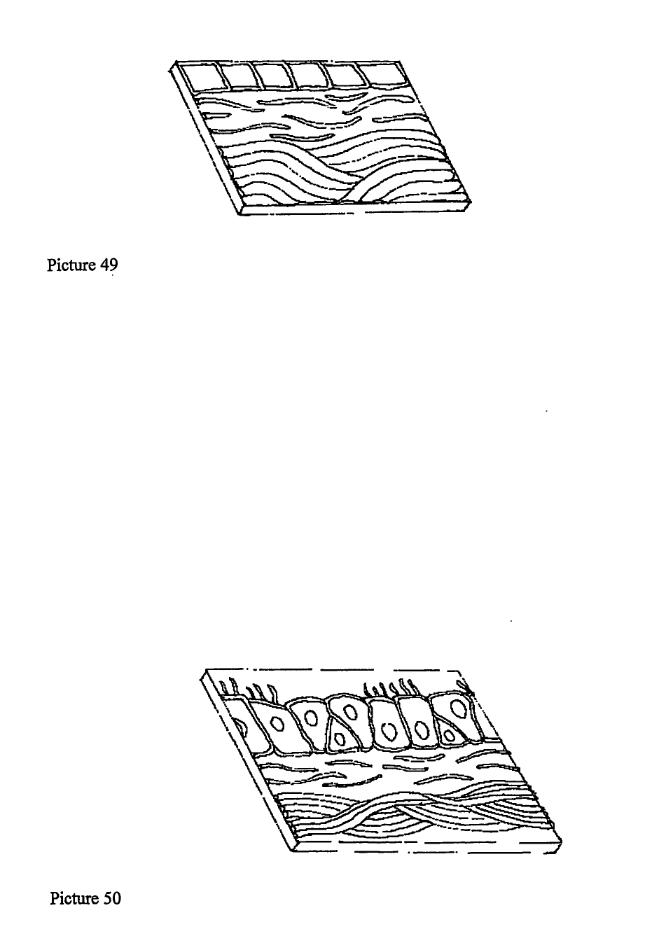

FIG. 54 shows, in relief, the product representing a section of simple squamous epithelial tissue, in greatly enlarged size.

FIG. 55 shows, in relief, the product representing a section of simple cuboidal epithelial tissue, in greatly enlarged size.

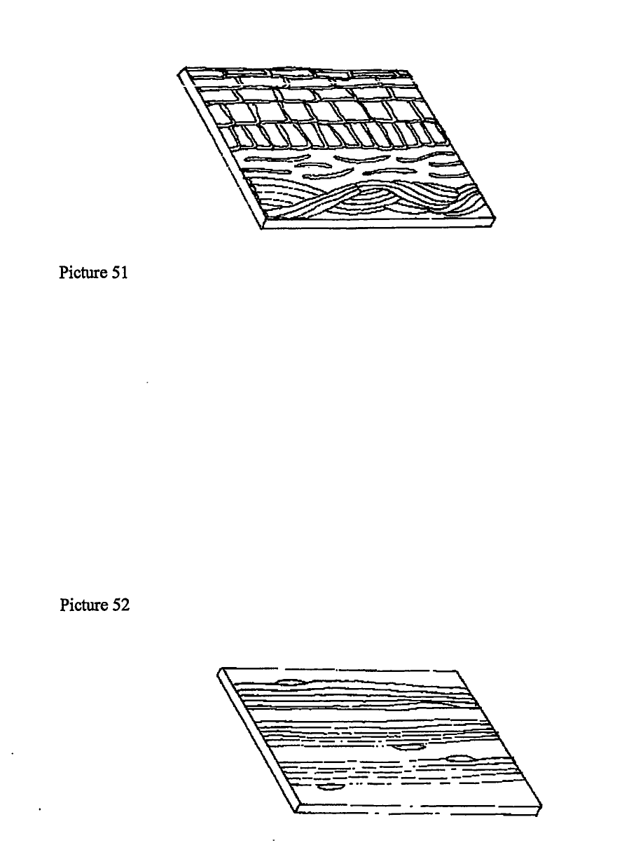

FIG. 56 shows, in relief, the product representing a section of simple ciliatpseudostratified epithelial tissue, in greatly enlarged size.

FIG. 57 shows, in relief, the product representing a section of non-keratinized stratified squamous epithelial tissue, in greatly enlarged size.

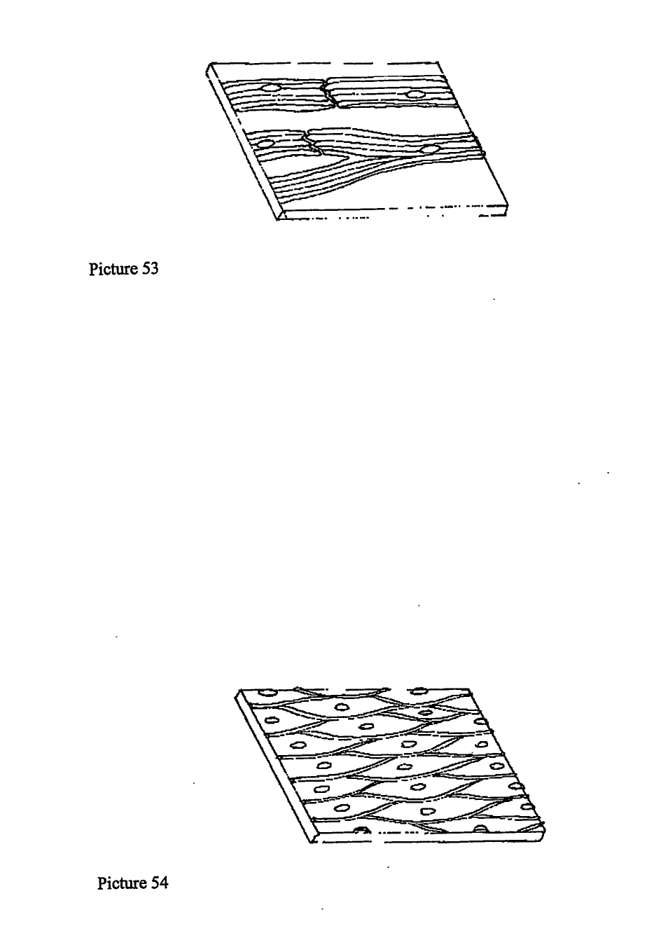

FIG. 58 shows, in relief, the product representing a section of smooth muscle tissue, in greatly enlarged size.

FIG. 59 shows, in relief, the product representing a section of striated skeletal muscle tissue, in greatly enlarged size.

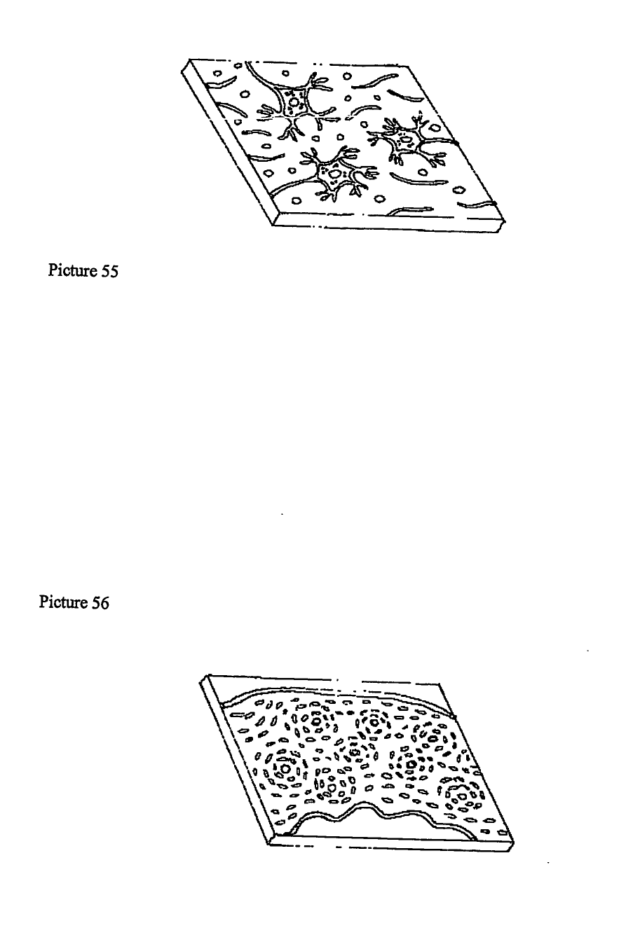

FIG. 60 shows, in relief, the product representing a section of striated cardiac muscle tissue, in greatly enlarged size.

FIG. 61 shows, in relief, the product representing a section of nerve tissue, in greatly enlarged size.

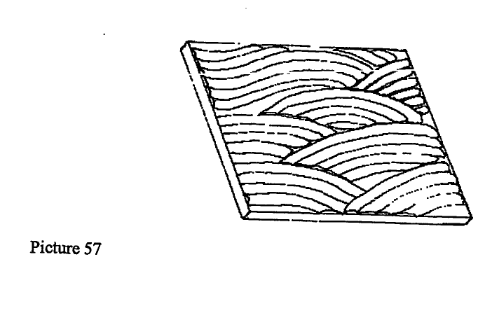

FIG. 62 shows, in relief, the product representing a section of bone tissue, in greatly enlarged size.

FIG. 63 shows, in relief, the product representing a section of connective tissue, in greatly enlarged size.

1. Collection of cytological, histological products, of human embryonic and fetal development and of three-dimensional organs and organs in relief, and the interpretative process in printed form and in braille characterized by a set of 51 products and a process of didactic interpretation relating the dimensions, topography and proportions of the structures under study.

2-59. (canceled)
